(19) United States
(12) Patent Application Publication
(10) Pub. No.: US 2024/0169129 A1
(43) Pub. Date: May 23, 2024

(54) ITERATIVE BOOTSTRAPPING NEUROSYMBOLIC METHOD FOR GENERATING SYSTEM DESIGNS

(71) Applicant: SRI International, Menlo Park, CA (US)

(72) Inventors: Adam Derek Cobb, Washington, DC (US); Daniel Elenius, Redwood City, CA (US); Anirban Roy, San Francisco, CA (US); Patrick Denis Lincoln, Woodside, CA (US); Susmit Jha, Redwood City, CA (US)

(21) Appl. No.: 18/512,812

(22) Filed: Nov. 17, 2023

Related U.S. Application Data
(60) Provisional application No. 63/384,130, filed on Nov. 17, 2022.

(51) Int. Cl. G06F 30/27

(52) U.S. Cl. CPC G06F 30/27; G06F 2119/02

(57) ABSTRACT

In an example, an iterative method for generating designs includes receiving, by a computing system, a plurality of symbolic rules and a plurality of design objectives for a design of a system; generating, by the computing system, a first plurality of designs for the system based on the plurality of the symbolic rules; evaluating performance of the first plurality of designs; training a machine learning model using the first plurality of designs and performance metrics; generating a second plurality of designs; evaluating, by the computing system, using a machine learning model, performance of the second plurality of designs to filter one or more designs that meet one or more of the plurality of the design objectives; evaluating performance of the filtered designs; and updating, by the computing system, the plurality of the design objectives and/or the plurality of the symbolic rules based on the evaluated performance of the filtered designs.

This application claims the benefit of U.S. patent application Ser. No. 63/384, 130, filed Nov. 17, 2022, which is incorporated by reference herein in its entirety.

### GOVERNMENT RIGHTS

This invention was made with Government support under contract number. FA8750-20-C-0002 awarded by the United States Air Force and the Defense Advanced Research Projects Agency, and under grant number CNS-1740079 awarded by the National Science Foundation. The Government has certain rights in this invention.

### TECHNICAL FIELD

This disclosure is related to computing systems, and more specifically to generating models for system designs.

### BACKGROUND

The iterative process of physical design using simulation models is slow and limiting because it requires experts to manually explore a small design space. Simulation models are often complex and computationally expensive to run. Additionally, it may be difficult to leverage both symbolic and parametric components of the design space in these approaches. Symbolic components of the design space refer to the relationships between different design parameters. For example, the relationship between the thickness of a material and its strength is a symbolic component of the design space. Parametric components of the design space refer to the specific values of design parameters. For example, the specific thickness of a material is a parametric component of the design space.

Physical design is the process of converting a logical design into a physical layout. Physical design process may involve making decisions about the placement of components, the routing of interconnects, and the power distribution. Physical design is a complex and challenging task and is typically done by experts using simulation models. Simulation models may be used to predict the performance of a physical design. The simulation models may be used to identify and fix potential problems, such as congestion, timing violations, and power dissipation. However, simulation models may be complex and computationally expensive to run. As a result, designers are typically limited to exploring a small design space.

Tools that are focused on optimizing the parameters of simulation models may help to speed up the design process. However, the parameter optimization tools are limited in their use because these tools do not leverage both symbolic and parametric components of the design space. In other words, the parameter optimization tools cannot be used to explore all of the possible design solutions. Furthermore, when entering a new design domain, it is common to not have training data to train machine learning models because design domains are often unique and complex, and it may be difficult to collect a large and representative dataset of good designs. Additionally, even if we there is a corpus of existing good designs, it may be difficult to train a model to generate innovative designs based on known ones.

### SUMMARY

In general, the disclosure describes iterative neurosymbolic bootstrapping techniques. The techniques may be applied to the design of physical systems. Neurosymbolic bootstrapping is a technique for designing systems that combines data-driven neural approaches with symbolic generation.

A surrogate model is a type of machine learning model that is trained to predict the performance of a system without having to build and test a prototype. The results of these evaluations may then be used to refine a symbolic grammar, which may then be used to generate even better designs. This process may be repeated until a satisfactory design is found. The neurosymbolic bootstrapping techniques have several advantages over traditional design methods. First, the neurosymbolic bootstrapping techniques may be used to design systems in domains where there is little or no existing data. Second, the neurosymbolic bootstrapping technique may be used to generate innovative designs that are not simply variations on existing designs. Third, the neurosymbolic bootstrapping techniques may be used to automate the design process, which may save time and money.

An example set of steps involved in the neurosymbolic bootstrapping techniques is as follows. First, a symbolic grammar which is both parametric and probabilistic may be built. Second, the symbolic grammar may be used to generate structured data instances, such as, but not limited to, design topologies and compositional shapes. Third, a surrogate model may be trained to predict the performance of a system based on its structured data instance. Fourth, the structured data instances may be evaluated using the surrogate model. Fifth, the symbolic grammar may be refined based on the results of the evaluation. Sixth, second through fifth steps may be repeated iteratively until a satisfactory design is found.

In an example, an iterative method for generating designs in a computationally efficient manner includes receiving, by a computing system, a plurality of symbolic rules and a plurality of design objectives for a design of a system; generating, by the computing system, a first plurality of designs for the system based on the plurality of the symbolic rules; evaluating performance of the first plurality of designs; training a machine learning model using the first plurality of designs and performance metrics; generating a second plurality of designs; evaluating, by the computing system, using a machine learning model, performance of the second plurality of designs to filter one or more designs that meet one or more of the plurality of the design objectives; evaluating performance of the filtered designs; and updating, by the computing system, the plurality of the design objectives and/or the plurality of the symbolic rules based on the evaluated performance of the filtered designs such that the symbolic rules and objectives become more restrictive.

In an example, a computing system comprises: an input device configured to receive a plurality of symbolic rules and a plurality of design objectives for a design of a system; processing circuitry and memory for executing a design generation system, wherein the design generation system is configured to: generate a first plurality of designs for the system based on the plurality of the symbolic rules; evaluate performance of the first plurality of designs; train a machine learning model using the first plurality of designs and performance metrics; generate a second plurality of designs; evaluate, using a machine learning model, performance of the second plurality of designs to filter one or more designs that meet one or more of the plurality of the design objectives; evaluate performance of the filtered designs; and update the plurality of the design objectives and/or the plurality of the symbolic rules based on the evaluated performance of the filtered designs such that the plurality of symbolic rules and the plurality of the design objectives become more restrictive.

In an example, non-transitory computer-readable media comprises machine readable instructions for configuring processing circuitry to: receive a plurality of symbolic rules and a plurality of design objectives for a design of a system; generate a first plurality of designs for the system based on the plurality of the symbolic rules; evaluate performance of the first plurality of designs; train a machine learning model using the first plurality of designs and performance metrics; generate a second plurality of designs; evaluate, using a machine learning model, performance of the second plurality of designs to filter one or more designs that meet one or more of the plurality of the design objectives; evaluate performance of the filtered designs; and update the plurality of the design objectives and/or the plurality of the symbolic rules based on the evaluated performance of the filtered designs such that the plurality of symbolic rules and the plurality of the design objectives become more restrictive.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 depicts a block diagram of an example of a computing system in accordance with the techniques of the disclosure.

FIG. 2 is a block diagram illustrating components of an example system in accordance with the techniques of the disclosure.

FIG. 3 is a block diagram illustrating an example of an improved design flow in accordance with the techniques of the disclosure.

FIG. 4 is a block diagram illustrating an alternative example of an improved design flow according to techniques of this disclosure.

FIG. 5 is a conceptual diagram illustrating an example of neurosymbolic generation of physical designs of unmanned aerial vehicles (UAVs) according to techniques of this disclosure.

FIG. 6 is a conceptual diagram illustrating an example representation of physical design according to techniques of this disclosure.

FIGS. 7A and 7B are graphs illustrating an example of results on an example corpus according to techniques of this disclosure.

FIG. 8 is a flowchart illustrating an example mode of operation for a design generation system, according to techniques described in this disclosure.

Like reference characters refer to like elements throughout the figures and description.

### DETAILED DESCRIPTION

The disclosure describes iterative neurosymbolic bootstrapping techniques for the design of systems. Existing tools for design, including physical design, are generally focused on optimizing the parameters of simulation models.

Focusing on optimizing the parameters of simulation models may help to speed up the design process, but such focus does not address the fundamental problem of exploring a large design space. As described herein, a system applying techniques of this disclosures automatically explores a large design space and leverages both symbolic and parametric components of the design space, which may allow designers to find better solutions more quickly that is possible with existing tools. Symbolic components of the design space refer to the relationships between different design parameters. For example, the relationship between the thickness of a material and its strength may be a symbolic component of the design space. Parametric components of the design space refer to the specific values of design parameters. For example, the specific thickness of a material may be a parametric component of the design space.

By exploring a large design space and identifying the best solutions, the disclosed system may help designers to reduce the time it takes to design a system. By leveraging both symbolic and parametric components of the design space, the disclosed system may help designers to find innovative and creative solutions that would not be possible using traditional methods. The disclosed system may automate the design process, freeing up designers to focus on more strategic tasks. There are two main problems that exist when entering a new design domain with machine learning. First, it may be difficult to collect a large and representative dataset of good designs in a new domain because design domains are often unique and complex. Second, even if there is a corpus of existing good designs, it may be difficult to train a machine learning model to generate innovative designs based on known designs because innovation requires the ability to think “outside of the box” and generate new ideas that are not simply variations on existing designs.

Transfer learning is a machine learning technique that enables transfer of knowledge learned from one task to another. In the context of design, this means that a machine learning model may be trained on a dataset of designs from a different domain, and then that model may be used to generate designs in the new domain. For example, a machine learning model may be trained on a dataset of furniture designs, and then that model may be to generate new kitchen designs. Generative models are machine learning models that may be used to generate new data samples. In the context of design, a generative model may be used to generate new designs from scratch.

One way to generate new designs is to use a generative adversarial network (GAN). GANs are a type of generative model that may be trained to generate realistic and diverse data samples.

Human-in-the-loop design is a process that combines the creativity of humans with the power of machines. In this approach, a machine learning model may be used to generate a set of design proposals, and then a human designer may select the best proposals and may provide feedback to the model. The model may then use the provided feedback to generate a new set of proposals, and the process may continue until the designer is satisfied with the results.

The aforementioned techniques are all promising for addressing the challenges of machine learning for design in new domains. However, they are still under development, and there are some challenges that need to be addressed before the aforementioned techniques may be widely used.

In contrast to the aforementioned techniques, this disclosure describes novel iterative neurosymbolic bootstrapping techniques for the design of systems, which may include physical systems. Neurosymbolic bootstrapping is a machine learning approach for designing systems. The disclosed technique may start with a set of basic design rules and then may use machine learning/AI to fine-tune the design rules to generate a novel set of diverse designs that meet certain design objectives.

The disclosed process may be iterative and may be implemented as follows. The first step in this process may be to generate a large corpus of random designs. This step may be implemented using a variety of methods, such as procedural generation, genetic algorithms, or other optimization techniques. The goal may be to create a diverse set of designs that span the range of possibilities for the problem being solved. Once a corpus of designs has been generated, each design may be passed through a simulator. The simulator is a model of the system that is being designed, and the simulator may be used to calculate the performance metrics for each design. These performance metrics could include, but are not limited to parameters such as strength, weight, cost, efficiency, and the like. The performance metrics that are calculated by the simulator may then be used to train a machine learning model. The machine learning model may be trained to learn the relationship between the design parameters and the performance metrics. The machine learning model may be trained by a feed of the design parameters and the corresponding performance metrics for each design. The machine learning model may then learn to predict the performance metrics for new designs. The machine learning model may be trained multiple times to ensure that the machine learning model is generalizing well and that the machine learning model is not simply overfitting to the training data. Overfitting occurs when a model learns the training data too well and is unable to make accurate predictions on new data. Once the machine learning model has been trained, such trained machine learning system may be used to predict the performance metrics for new designs. The described process allows designers to quickly filter out designs that are unlikely to meet their requirements. In an aspect, the described process may be repeated iteratively, with the machine learning model being retrained after each iteration. Such iterative retraining may help to improve the accuracy of the machine learning model and to identify even better designs.

In addition, the best designs may be used to update the design objectives and/or the basic symbolic rules. These symbolic rules may be thought of as a set of instructions that tell the system how to create new designs. By updating the symbolic rules based on the evaluations from the machine learning model, the system may learn to create better designs over time. Such update may be implemented using a variety of methods, such as genetic algorithms or particle swarm optimization. The aforementioned process may be repeated until the design objectives are met or until a certain number of iterations have been completed.

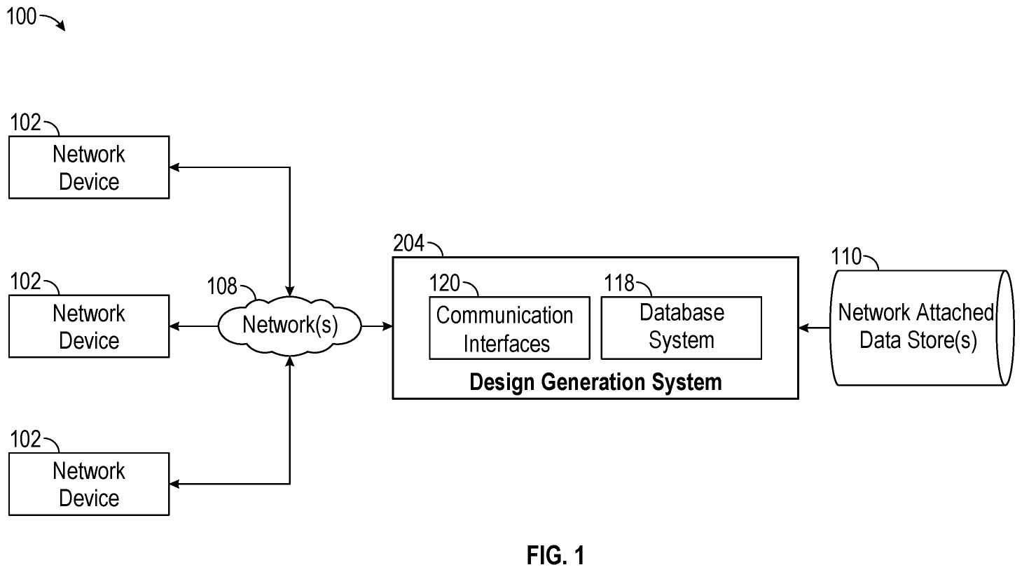

FIG. 1 is a block diagram of an example of the hardware components of a computing system according to some aspects. System 100 is a specialized computer system that may be used for processing large amounts of data where a design generation system may be implemented.

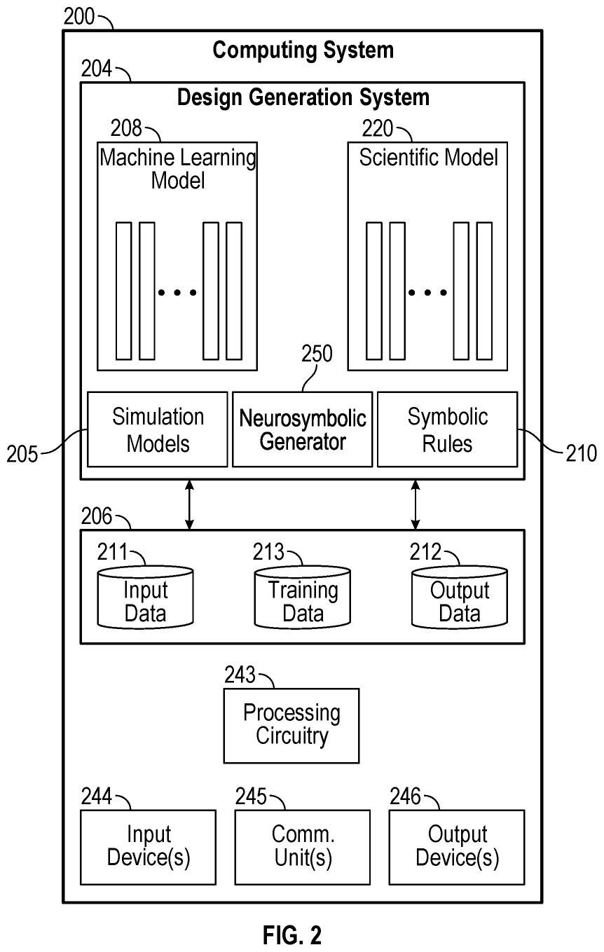

System 100 may also include design generation system 204 described in greater detail in relation to FIG. 2. Design generation system 204 may be a specialized computer or other machine that processes the data received within the system 100. The design generation system 204 may include one or more other systems. For example, design generation system 204 may include a database system 118 and/or one or more communication interfaces 120. The design generation system 204 may include one or more processing devices (e.g., distributed over one or more networks or otherwise in communication with one another) that may collectively be referred to herein as a processor or a processing device.

System 100 may also include one or more network devices 102. Network devices 102 may include client devices that can communicate with design generation system 204. For example, network devices 102 may send data to the design generation system 204 to be processed, may send communications to the design generation system 204 to control different aspects of the computing environment or the data it is processing, among other reasons. Network devices 102 may interact with the design generation system 204 through a number of ways, such as, for example, over one or more networks 108.

In some examples, network devices 102 may provide a large amount of design data, either all at once or streaming over a period of time (e.g., using event stream processing (ESP)), to the design generation system 204 via networks 108. For example, the network devices 102 may transmit electronic messages for use in executing an iterative bootstrapping process, all at once or streaming over a period of time, to the design generation system 204 via networks 108.

The network devices 102 may include network computers, sensors, databases, or other devices that may transmit or otherwise provide data to design generation system 204. For example, network devices 102 may include local area network devices, such as routers, hubs, switches, or other computer networking devices. These devices may provide a variety of stored or generated data, such as network data or data specific to the network devices 102 themselves. Network devices 102 may also include sensors that monitor their environment or other devices to collect data regarding that environment or those devices, and such network devices 102 may provide data they collect over time. Network devices 102 may also include devices within the internet of things, such as devices within a home automation network. Some of these devices may be referred to as edge devices and may involve edge-computing circuitry. Data may be transmitted by network devices 102 directly to design generation system 204 or to network-attached data stores, such as network-attached data stores 110 for storage so that the data may be retrieved later by the design generation system 204 or other portions of system 100. For example, the network devices 102 may transmit physical design data usable in an iterative bootstrapping process to a network-attached data store 110 for storage. The design generation system 204 may later retrieve the data from the network-attached data store 110 and use the data (e.g., training data, rules data, and the like) in an iterative bootstrapping process.

Network-attached data stores 110 may store data to be processed by the design generation system 204 as well as any intermediate or final data generated by the computing system in non-volatile memory. But in certain examples, the configuration of the design generation system 204 allows its operations to be performed such that intermediate and final data results may be stored solely in volatile memory (e.g., RAM), without a requirement that intermediate or final data results be stored to non-volatile types of memory (e.g., disk). This may be useful in certain situations, such as when the design generation system 204 receives ad hoc queries from a user and when design candidates, which are generated by processing large amounts of data, need to be generated dynamically (e.g., on the fly).

Network-attached data stores 110 may store a variety of different types of data organized in a variety of different ways and from a variety of different sources. For example, network-attached data stores 110 may include storage other than primary storage located within design generation system 204 that is directly accessible by processors located therein. Network-attached data stores 110 may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data may be stored and that does not include carrier waves or transitory electronic communications. Examples of non-transitory media may include, for example, a magnetic disk or tape, optical storage media such as compact disk or digital versatile disk, flash memory, memory or memory devices. A computer-program product may include code or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data.

The unstructured data may be presented to the design generation system 204 in different forms such as a flat file or a conglomerate of data records and may have data values and accompanying time stamps. The design generation system 204 may be used to analyze the unstructured data in a variety of ways to determine the best way to structure (e.g., hierarchically) that data, such that the structured data is tailored to a type of further analysis that a user wishes to perform on the data. For example, after being processed, the unstructured time-stamped data may be aggregated by time (e.g., into daily time period units) to generate time series data or structured hierarchically according to one or more dimensions (e.g., parameters, attributes, or variables). For example, data may be stored in a hierarchical data structure, such as a relational online analytical processing (ROLAP) or multidimensional online analytical processing (MOLAP) database, or may be stored in another tabular form, such as in a flat-hierarchy form.

It is to be further understood that, because some of the constituent system components and method steps depicted in the accompanying figures may be implemented in software, the actual connections between the systems components (or the method steps) may differ depending upon the manner in which the present disclosure is programmed. Given the teachings of the present disclosure provided herein, one of ordinary skill in the related art will be able to contemplate these and similar implementations or configurations of the present disclosure.

FIG. 2 is a block diagram illustrating an example computing system 200. In an aspect, computing system 200 may comprise an instance of the system 100. As shown, computing system 200 comprises processing circuitry 243 and memory 206 for executing components of the design generation system 204. Such components may include neurosymbolic generator 250, simulation models 205, machine learning models 208, symbolic rules 210, and scientific models 220 that may form an overall framework for performing one or more techniques described herein.

Computing system 200 may be implemented as any suitable computing system, such as one or more server computers, workstations, laptops, mainframes, appliances, cloud computing systems, High-Performance Computing (HPC) systems (i.e., supercomputing), handheld devices, tablets, mobile telephones, smartphones, and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 206 may comprise one or more storage devices. One or more components of computing system 200 (e.g., processing circuitry 243, memory 206, input device(s) 244, communication unit(s) 245, and output device(s) 246) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 206 may be distributed among multiple devices.

Memory 206 may store information for processing during operation of computing system 200. In some examples, memory 206 comprises temporary memories, meaning that a primary purpose of the one or more storage devices of memory 206 is not long-term storage. Memory 206 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 206, in some examples, may also include one or more computer-readable storage media. Memory 206 may be configured to store larger amounts of information than volatile memory. Memory 206 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 206 may store program instructions and/or data associated with one or more of the modules described in accordance with one or more aspects of this disclosure.

Processing circuitry 243 and memory 206 may provide an operating environment or platform for one or more modules or units (e.g., neurosymbolic generator 250, simulation models 205, machine learning models 208), which may be implemented as software, but may in some examples include any combination of hardware, firmware, and software. Processing circuitry 243 may execute instructions and the one or more storage devices, e.g., memory 206, may store instructions and/or data of one or more modules. The combination of processing circuitry 243 and memory 206 may retrieve, store, and/or execute the instructions and/or data of one or more applications, modules, or software. The processing circuitry 243 and/or memory 206 may also be operably coupled to one or more other software and/or hardware components, including, but not limited to, one or more of the components illustrated in FIG. 2.

Processing circuitry 243 may execute components of the design generation system 206 using virtualization modules, such as a virtual machine or container executing on underlying hardware. One or more of such modules may execute as one or more services of an operating system or computing platform. Components of the design generation system 206 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like. In some examples, communication units 245 may be included in the communication interfaces 120 illustrated in FIG. 1.

In the example of FIG. 2, neurosymbolic generator 250 may receive input data from an input data set 211 and may generate output data 212. Input data 211 and output data 212 may contain various types of information. For example, input data 211 may include specific design objectives, such as performance, cost, and manufacturability. Output data 212 may include design examples, design candidates, and so on. In an aspect, input data 211, output data 212 and training data 213 may be stored in the database system 118 shown in FIG. 1

Neurosymbolic bootstrapping has a number of advantages over traditional design methods. First, neurosymbolic bootstrapping may be used to design systems in domains where there is little or no existing data. Second, neurosymbolic bootstrapping may be used to generate innovative designs that are not simply variations on existing designs. Third, neurosymbolic bootstrapping may be used to automate the design process, which may save time and money. Following is an example of how neurosymbolic bootstrapping could be used to design a physical system, in this case a new aircraft design. In general, a physical system is one that has design objectives based primarily on interactions of the system with the physical environment in which the system operates. Physical systems can include vehicles, ships, crafts, buildings, appliances, instruments, gadgets, production lines, transportation systems, warehouses, satellites, or other physical systems or components thereof. Other types of systems that may be designed using techniques described herein include, for instance, computing systems, neural network models, network systems, and other systems, or components thereof, in which the design objects are not based primarily on interactions of the system with the physical environment in which the system operates.

Symbolic rules 210 may include one or more basic design rules that indicate relationship among different components, parameters, or other features of a system under design. For this aircraft design example, the design generation system 204 may start with a set of basic design rules (here, symbolic rules 210) about aircraft design, such as, but not limited to, the relationship between wing area and lift, or the relationship between engine power and thrust. The design generation system 204 may use symbolic rules 210 to generate a set of design candidates (designs) for the new aircraft. Next, the design generation system 204 may evaluate these design candidates using a machine learning model to predict their respective performances along one or more performance dimensions. In an aspect, the design generation system 204 may use the best design candidates to update symbolic rules 210. The aforementioned steps may be repeated by the design generation system 204 until a satisfactory design for a new aircraft is found.

The problem of designing systems may be split into three subtasks.

The first subtask may involve building a set of general rules as part of a knowledge base (or grammar) that describes the design space. This is a challenging subtask because it may require a deep understanding of the physics and/or engineering principles that govern the design space. The knowledge base should be comprehensive enough to capture the full range of possible designs, but it should also be concise enough to be computationally efficient.

The second subtask may involve overcoming the significant challenge of evaluating designs without calling expensive simulation models. Many companies have simulation models that take a long time to run. Accordingly, it may be impractical to evaluate every possible design using a simulation model. A solution to this problem may be to develop surrogate models that may approximate the behavior of the simulation models much faster.

In an aspect, the third subtask may involve updating the knowledge base/rules to ensure that proposed designs meet their design objectives. This may be a critical subtask because it ensures that the proposed designs are feasible and meet the desired performance requirements. Design generation system 204 addresses this problem by using machine learning to learn the relationship between the design parameters and the performance objectives. The learned information may then be used by the design generation system 204 to update the knowledge base/rules to generate, in future iterations, designs that are more likely to meet the design objectives.

In an aspect, neurosymbolic bootstrapping could be used to automatically extract symbolic rules from existing design data. For example, it could be used to extract symbolic rules from a dataset of aircraft designs. These symbolic rules could then be used to generate new aircraft designs with improved performance, efficiency, and safety. For example, the design generation system 204 may use neurosymbolic bootstrapping to extract symbolic rules 210 from a dataset of aircraft designs. These rules could then be used to generate new aircraft designs with improved performance, efficiency, and safety. In addition, the design generation system 204 may use neurosymbolic bootstrapping to develop surrogate models that may approximate the behavior of the simulation models much faster.

In an aspect, the surrogate models (represented by machine learning model 208) would make it possible to evaluate a large number of design candidates without having to run the expensive simulation models. In addition, neurosymbolic bootstrapping could be used by the design generation system 204 to use machine learning to learn the relationships among the design parameters and the performance objectives. The design generation system 204 may use this relationship information to update the knowledge base/rules so that they generate designs that are more likely to meet the design objectives. As noted above, existing tools for designing systems are typically limited in their ability to explore a large design space and to generate innovative designs because they often rely on simulation models, which may be expensive and time-consuming to run. Additionally, existing systems may not be able to leverage both symbolic and parametric components of the design space.

In an aspect, the neurosymbolic generator 250 for design may be a program that uses the symbolic rules 210 to produce instances of high-level designs. The neurosymbolic generator 250 may make it possible to explore a large design space and to generate innovative designs.

Additionally, the neurosymbolic generator 250 may be biased in different ways to express designs that are more conservative or reasonable, as compared to more innovative but less likely to work. The bias may be configurable. Multiple such generators may be written for the same design language. In an aspect, the neurosymbolic generator 250 may explore a large design space and identify the best solutions quickly, reducing the time it takes to design a system.

In an aspect, the neurosymbolic generator 250 may leverage both symbolic and parametric components of the design space, which may lead to more innovative and creative designs. The neurosymbolic generator 250 may automate the design process, freeing up designers to focus on more strategic tasks.

The following are some examples of how the neurosymbolic generator 250 could be used for designing physical systems. To design a new aircraft, the neurosymbolic generator 250 may be used to generate a set of design candidates for different wing shapes, tail shapes, and engine configurations. The generated design candidates could then be evaluated using machine learning models to identify the best designs. To design a new battery, the neurosymbolic generator 250 could be used to generate a set of design candidates for different electrode materials, electrolyte materials, and cell architectures. The generated design candidates could then be evaluated using the machine learning models to identify the best designs. To design a new solar cell, the neurosymbolic generator 250 could be used to generate a set of design candidates for different absorber materials, anti-reflection coatings, and back contacts. The generated design candidates could then be evaluated using simulation models to identify the best designs.

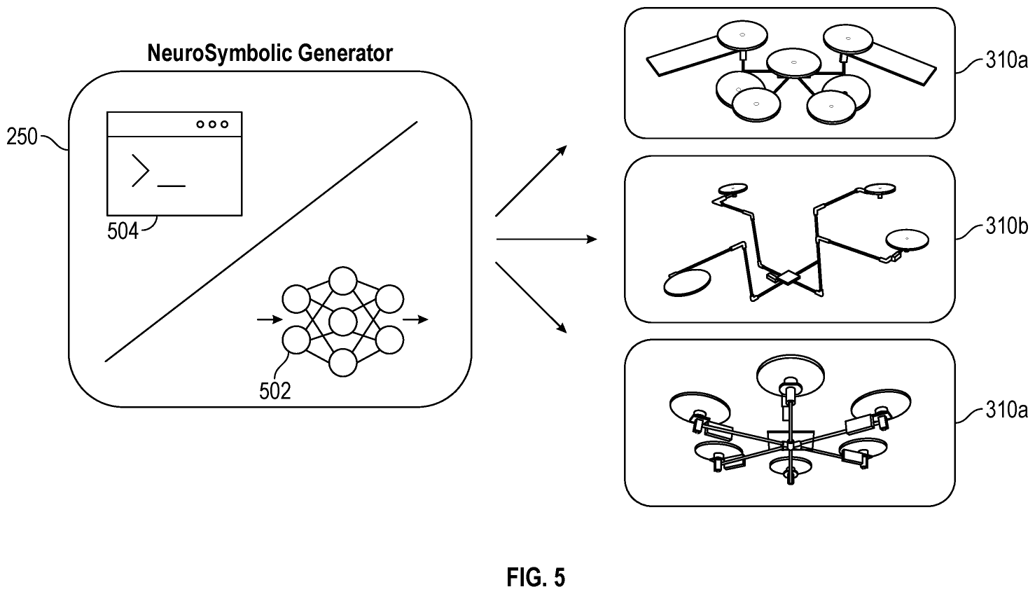

In an aspect, the neurosymbolic generator 250 may include a transformer encoder model 502 (shown in FIG. 5). A transformer encoder model (or more simply, “transformer model”) is a type of neural network that is particularly well-suited for processing sequential data, such as text. The transformer encoder model 502 may be used to learn the relationships between different parts of a sequence and to generate new sequences. In the context of physical design, the transformer encoder model 502 may be trained to predict over the design objectives, given the design grammar in the form of text.

The transformer encoder model 502 of the neurosymbolic generator 250 may then be used to fine-tune designs to meet certain criteria. For example, the design generation system 204 may be configured to design a new aircraft and the objective may be to find a design that maximizes fuel efficiency while minimizing noise levels. The transformer encoder model 502 may be trained on a dataset of existing aircraft designs and their corresponding fuel efficiency and noise level measurements. The transformer encoder model 502 would learn to predict the fuel efficiency and noise level of a new aircraft design based on its design grammar. Once the transformer encoder model 502 is trained, the design generation system 204 could use it to fine-tune a new aircraft design to meet the desired criteria. For example, the design generation system 204 could generate a set of design candidates using the neurosymbolic generator 250 described above. In an aspect, the design generation system 204 may then feed these design candidates to the transformer encoder model 502 to predict their fuel efficiency and noise levels. The design generation system 204 could then select the design candidate with the highest fuel efficiency and the lowest noise level. This process could be repeated iteratively to fine-tune the design to meet the desired criteria.

The transformer encoder model 502 used to predict over the design objectives is also known as a neural surrogate model. Neural surrogate models are often used in engineering design to reduce the need to run expensive and time-consuming simulation models. The following is an example of how a neural surrogate model could be used to design a new battery. The transformer encoder model 502 may be trained on a dataset of existing battery designs and their corresponding energy density, power density, cycle life, and cost data. A set of design candidates may be generated using the neurosymbolic generator 250, as described above. The design generation system 204 may feed the design candidates to the transformer encoder model 502 to predict their energy density, power density, cycle life, and cost.

The neural surrogate transformer model 502 may be retrained using both the original data from the initial probabilistic symbolic generator 504 (shown in FIG. 5) and the data generated from the neurosymbolic generator 250. This iterative/bootstrapping process may take the human out of the loop of design and also may utilize symbolic representations of design (e.g., symbolic rules 210) that are valid such that each design may be evaluated on the scientific simulator (e.g., scientific model 220). The design generation system 204 may train a neural surrogate transformer model on the original data from the initial probabilistic symbolic generator 504. The design generation system 204 may use the neural surrogate transformer model to generate a new set of design candidates. The design generation system may evaluate the new set of design candidates using the scientific model 220. The design generation system may add the evaluated design candidates to the training data set 213.

In an aspect, simulation models 205 may emulate an example design by simulating the operations of the physical object represented by the example design. Simulation models 205 may also determine if the example design satisfies criteria provided in the design specification.

In an aspect, the design generation system 204 may implement a new technique to approach design in a manner that combines both topological and parametric data. The design generation system 204 may link two kinds of models together: the transformer model 502 (shown in FIG. 5) for evaluation and the probabilistic symbolic generator 504 for partial generation. The transformer model 502 may be trained on a dataset of existing physical designs and their corresponding performance metrics. The probabilistic symbolic generator 504 may be a generative model that may generate new design candidates based on a set of rules and constraints.

The techniques described herein may reduce the cost of simulation-based design for physical systems in a number of ways. First, the neurosymbolic generator 250 may be used to generate a large number of design candidates, which can then be evaluated using a surrogate model instead of an expensive simulation model. Second, the neurosymbolic generator 250 may be used to explore a much larger design space than traditional design methods, which can lead to more innovative and cost-effective designs. Third, the iterative bootstrapping process may be used to train the neurosymbolic generator 250 on a small set of existing design examples, which may reduce the need to generate and evaluate a large number of design candidates.

Following is a specific example of how the techniques disclosed herein may be used to reduce the cost of simulation-based design for physical systems. The neurosymbolic generator 250 may be used to generate a large number of design candidates for new aircraft and spacecraft designs. These design candidates may then be evaluated using a surrogate model instead of an expensive computational fluid dynamics (CFD) simulation model. Once a fine-tuned neurosymbolic generator 250 model is built, it may be re-used on multiple occasions for different objectives because the neurosymbolic generator 250 may be trained on both symbolic and parametric data, which may give it the ability to generalize to new objectives. To update the neurosymbolic generator 250 to new objectives, the current database of designs and bootstrap may be used to further update the model. By analyzing the performance of designs that have already been evaluated, the neurosymbolic generator 250 may identify areas where the design objectives or symbolic rules are too loose and need to be tightened. By tightening the design objectives or symbolic rules, the neurosymbolic generator 250 may focus its efforts on creating designs that are more likely to meet the desired performance criteria.

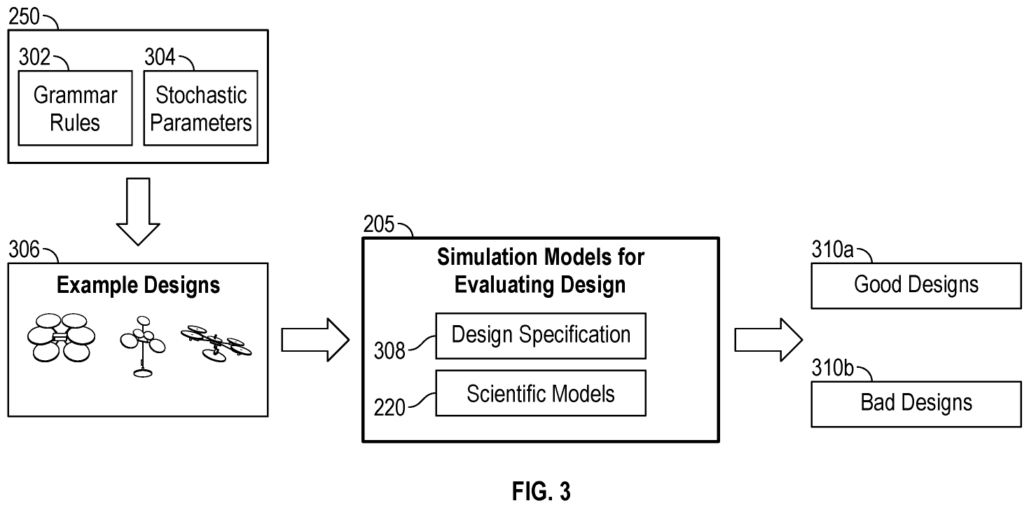

FIG. 3 is a block diagram illustrating an example of an improved design flow in accordance with the techniques of the disclosure. In an aspect, the neurosymbolic generator 250 may generate example designs for physical objects based on grammar rules 302 and stochastic parameters 304. Grammar rules 302 may specify a grammar that may be used to define a physical design space, such as, but not limited to, the structural and physical aspects of a design. Stochastic parameters 304 may provide values for attributes of components of the design, such as voltages, masses, and so on.

In an aspect, stochastic parameters 304 may be randomly varied to produce a variety of different example designs.

For example, the neurosymbolic generator 250 may be used to generate example designs 306 for aircraft. The grammar rules 302 may specify the different types of aircraft components, such as, but not limited to, wings, tail, and engines. The stochastic parameters 304 may provide values for the dimensions and materials of these components. The neurosymbolic generator 250 may then randomly vary the stochastic parameters 304 to generate a variety of different aircraft designs 306. The neurosymbolic generator 250 may be used to generate designs 306 in domains where there is little or no existing data, and they can be used to explore a much larger design space than traditional design methods. The neurosymbolic generator 250 may generate designs 306 that are outside the box and that would not be thought of by traditional design methods. The neurosymbolic generator 250 may generate a large number of design candidates quickly, which may reduce the time it takes to design a product. The neurosymbolic generator 250 may generate designs 306 that meet specific design objectives, such as performance, cost, and manufacturability.

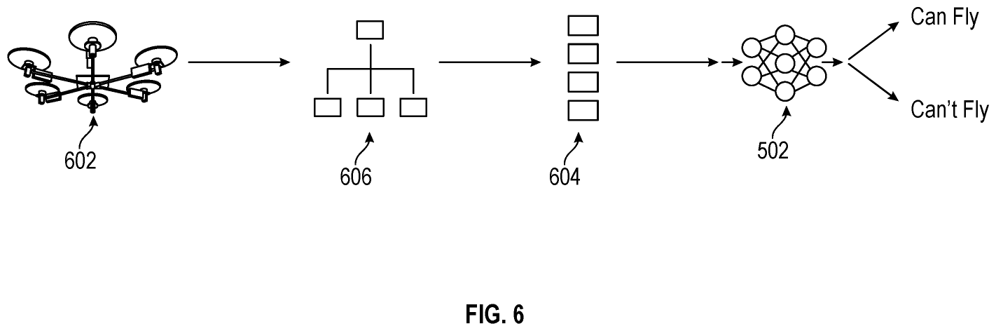

Advantageously, simulation models 205 may emulate an example design 306 by simulating the operations of the physical object represented by the example design 306. In the examples provided in the FIGS. 5 and 6, example designs 306 may be different designs for an unmanned aerial vehicle (UAV). The simulation model 205 may simulate the operation of the UAV based on the structure and operational parameters provided in the example design 306. The simulation model 205 may also determine if the example design 306 satisfies criteria provided in the design specification 308. For example, the design specification 308 may include criteria indicating that the UAV flies or does not fly. Example designs 306 may also be different designs for an unmanned subsurface vehicle (USV), unmanned ground vehicle (UGV), or other vehicle. Simulation models 205 are a powerful tool for evaluating design candidates and for determining if they meet the design objectives. In an aspect, the design objectives may include a set of control objectives and/or a set of physical objectives. Control objectives are objectives that relate to the behavior of the system being designed. For example, a control objective for a vehicle might be to minimize fuel consumption. Control objectives may be expressed in terms of variables that may be controlled by the system, such as the throttle position or the gear ratio. Physical objectives are objectives that relate to the physical properties of the system being designed. For example, a physical objective for a vehicle might be to minimize weight. Physical objectives cannot be controlled by the system, but they may be influenced by the design of the system.

The simulation models 205 may also be used to generate new design candidates 306 by modifying the parameters (e.g., stochastic parameters 304) of existing designs. Simulation models 205 may simulate the operation of physical systems much faster than traditional simulation methods. Simulation performed by simulation models 205 may save time and money in the design process. Simulation models 205 may be used to evaluate design candidates for a wide range of criteria, such as performance, cost, and manufacturability. Accordingly, simulation models 205 may help to ensure that the final design meets all of the design objectives (such designs are referred to hereinafter as good designs 310a and contrast with bad designs 310b). Simulation models 205 may be used to generate new design candidates 310 by modifying the parameters 304 of existing designs 306. Such modifications may help to explore a wider range of design alternatives and to find more innovative and efficient solutions. The following is an example of how a simulation model 205 could be used to design a new UAV. The neurosymbolic generator 250 may be used to generate a set of design candidates 306 for new UAV designs. A simulation model 205 may be used to simulate the operation of each design candidate 306. The simulation model 205 may evaluate the design candidates 306 for a variety of criteria, such as, but not limited to, flight performance, cost, and manufacturability. The simulation model 205 may select the design candidate 310a that meets all of the design objectives. The aforementioned process may be repeated iteratively to improve the design of the UAV.

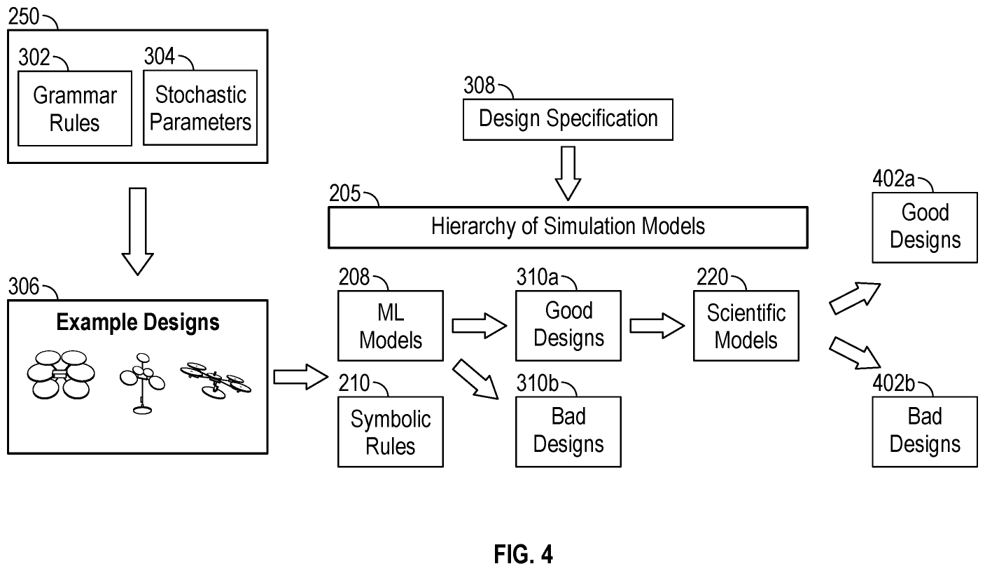

FIG. 4 is a block diagram illustrating an alternative example of an improved physical design flow according to techniques of this disclosure. In this alternative implementation, the design generation system 204 may use machine learning models 208 and symbolic rules 210 to evaluate example designs 306 and filter them into good designs 310a and bad designs 310b.

Machine learning models 208 may be trained on a dataset of existing designs and their corresponding performance metrics. The trained machine learning model 208 may then be used to predict the performance of new design candidates 306. Symbolic rules 210 may be used to encode design knowledge and constraints. For example, a symbolic rule 210 may be used to specify that the wings of an aircraft must be attached to the fuselage.

The design generation system 204 may use the output from the machine learning models 208 and symbolic rules 210 to filter the example designs 310. For example, the design generation system 204 may filter out any design candidates (e.g., bad designs 310b) that do not meet the symbolic rules 210 or that have a predicted performance below a certain threshold.

As a non-limiting example, the design generation system 204 may use neurosymbolic generator 250 to generate a set of design candidates 306 for new battery designs. The design generation system 204 may evaluate the design candidates 306 using machine learning models 208 and symbolic rules 210.

The ML models 208 may filter the design candidates 306 based on their predicted performance and compliance with the symbolic rules 210. The ML models 208 may select the design candidate 306 that has the best predicted performance and that meets substantially all of the symbolic rules 210. This process may be repeated iteratively to improve the design of the battery.

The design generation system 204 may automate the design process, which may save time and money. The design generation system 204 may use machine learning models 208 and symbolic rules 210 to evaluate design candidates 306 for a wide range of criteria, such as, but not limited to, performance, cost, and manufacturability.

As shown in FIG. 4, machine learning models 208 may help to ensure that the final design meets all of the design objectives. In other words, the design generation system 204 may be used to explore a wider range of design alternatives and to find more innovative and efficient solutions.

In an aspect, the design generation system 204 may further apply one or more

scientific models 220 to good designs 310a generated by the machine learning models 208 to further filter good designs 310a into good designs 402a and bad designs 402b. Scientific models 220 may be used to predict the behavior of physical systems under a variety of conditions. The predicted behavior information may be used to evaluate the performance of design candidates to identify one or more design candidates (e.g., good designs 310a) that meet the design objectives, and in some cases to identify any potential design flaws. For example, the scientific model 220 may be used to predict the aerodynamic performance of an aircraft design. The design generation system 204 may then use this information to filter out any design candidates that are likely to be unstable or that have poor fuel efficiency. Scientific models 220 may also be used to optimize the design of physical systems.

For example, the scientific model 220 may be used to optimize the design of a battery to maximize its energy density or to optimize the design of a heat sink to minimize thermal resistance. Following is an example of how the design generation system 204 may be used to design a new solar cell. The design generation system 204 may use neurosymbolic generator 250 to generate a set of design candidates 306 for new solar cell designs. The design generation system 204 may evaluate the design candidates 306 using machine learning models 208 and symbolic rules 210. The design generation system 204 may filter the design candidates 306 based on their predicted performance and compliance with the symbolic rules 210. The design generation system 204 may use a scientific model 220 to further optimize the remaining design candidates 310a. The design generation system 204 may select the design candidates (good designs 402a) that have the highest predicted performance and that meet substantially all of the design objectives.

In an aspect, the design generation system 204 may use the good designs 402a output from the scientific models 220 to tune a stochastic grammar, which may include at least the grammar rues 302 and stochastic parameters 304. Such tuning may be implemented by using the structures and parameters from the good designs 402a to update the grammar rules 302 and stochastic parameters 304 of the neurosymbolic generator 250. Such updates may allow the neurosymbolic generator 250 to generate better example designs 306 in the future. For example, the neurosymbolic generator 250 may be used for designing a new aircraft. The machine learning model 208 may generate a set of good design candidates 310a based on the example designs 306 generated by the neurosymbolic generator 250. The good design candidates 310a may be evaluated using the scientific model 220 to predict their aerodynamic performance. The good design candidate 402a with the best predicted performance may be selected. The structure and parameters of the selected good design candidate 402a may then be used to tune the stochastic grammar of the neurosymbolic generator 250. Such tuning may allow the neurosymbolic generator 250 to generate new design candidates 306 that are more likely to have good aerodynamic performance. The aforementioned process may be repeated iteratively to improve the performance of the neurosymbolic generator 250.

Tuning stochastic grammar using scientific models 220 may help the neurosymbolic generator 250 to generate better example designs 306. Accordingly, tuning stochastic grammar may lead to higher quality physical designs. Tuning stochastic grammar may also help the neurosymbolic generator 250 to explore a larger design space more efficiently. Accordingly, tuning stochastic grammar may lead to reduced design time and cost. In addition. tuning stochastic grammar may help the neurosymbolic generator 250 to generate more innovative designs. Accordingly, tuning stochastic grammar may lead to new and improved physical designs that were not possible before.

FIG. 5 is a conceptual diagram illustrating an example of neurosymbolic generation of unmanned aerial vehicle (UAV) designs according to techniques of this disclosure. In the example shown in FIG. 5, the design generation system 204 may include a neurosymbolic generator 250 that may include a transformer model 502. The transformer model 502 may be trained using a design grammar in the form of text and may be able to predict over the design objectives. After initial training, the design generation system 204 may combine the transformer model 520 with stochastic grammar to produce designs that meet the design objective (e.g., good designs 310a) by filtering out designs that do not meet the objectives (e.g., bad designs 310b). The neurosymbolic generator 250 may use the stochastic grammar to generate a set of design candidates. The transformer model 502 may be used to predict the performance of each design candidate for each of the design objectives. The design generation system 204 may filter out the design candidates that do not meet the design objectives. The remaining design candidates 310a may then be evaluated using the scientific model 220 to predict their performance for other criteria, such as cost and manufacturability. The design generation system 204 may then select the design candidate that best meets all of the design objectives and criteria. This process may be repeated iteratively to improve the design of the physical system. The transformer model 502 may be able to learn long-range dependencies in the design grammar, which may allow the transformer model 502 to generate more complex and innovative designs 310a. The transformer model 502 may be able to predict the performance of design candidates for multiple design objectives simultaneously, which may reduce the number of simulations that need to be run. The transformer model 502 may be able to be trained on a relatively small dataset of design examples, which may make it more practical to use in real-world design scenarios. The transformer model 502 may be trained on a dataset of existing aircraft designs and their corresponding performance metrics. The transformer model 502 may be used to generate a set of new design candidates for different wing shapes, tail shapes, and engine configurations of UAVs.

The transformer model 502 may be retrained using both the original data from the initial probabilistic symbolic generator 504 and the data generated from the neurosymbolic generator 250. This newly trained model may then be used to incrementally build the training data set 213 to ensure that designs produced by the neurosymbolic generator 250 are more likely to meet the design criteria specified in the design specification 308. As noted above, this process is known as bootstrapping. Bootstrapping is a technique that may be used to improve the performance of a machine learning model by training it on a larger dataset. In this case, the larger dataset may be created by combining the original data from the probabilistic symbolic generator 504 with the data generated from the neurosymbolic generator 250. The newly trained transformer model 502 may then be used to generate a new set of design candidates 310a. These design candidates 310a may be evaluated using the same criteria as the previous set of design candidates. The best design candidates may then be selected and added to the training data set 213. Bootstrapping has several advantages over traditional methods of training a machine learning model. First, bootstrapping may allow the model to be trained on a larger dataset, which may improve its performance. Second, bootstrapping may allow the model to be trained on a more diverse dataset, which may help to reduce overfitting. Third, bootstrapping may be used to train a model on data that is not labeled, which may save time and money. In the context of design generation, bootstrapping may be used to ensure that the neurosymbolic generator 250 is able to generate designs that meet the design criteria specified in the design specification 308. Bootstrapping is important because it allows the designer to focus on the high-level aspects of the design process, such as defining the design criteria and evaluating the design candidates, while the neurosymbolic generator 250 may take care of the low-level aspects of the design process, such as, but not limited to, generating and evaluating individual design candidates 310a.

In an aspect, data-driven approaches may be combined with symbolic knowledge representations to generate valid designs. A data-driven approach is one that uses data to learn patterns and make predictions, while a symbolic knowledge representation is one that uses symbols to represent and reason about knowledge. By combining these two approaches, the disclosed techniques create a system that may generate valid designs that are both creative and innovative. One way to combine these two approaches may be to employ the neurosymbolic generator 250 that uses both the transformer model 502 and the probabilistic symbolic generator 504 to generate the design candidates 310a. The transformer model 502 may be used to predict the performance of each design candidate, while the probabilistic symbolic generator 504 may be used to generate new design candidates 310a. The neurosymbolic generator 250 may be trained on a dataset of existing design examples. Once the neurosymbolic generator 250 is trained, the neurosymbolic generator 250 may be used to generate new design candidates that meet specific design criteria. Another way to combine data-driven approaches with symbolic knowledge representations may be to use the bootstrap approach.

Augmenting the grammar with data-driven models may help to improve the efficiency of the design generation process. Instead of having to generate and evaluate every possible design candidate, the data-driven models may be used to predict the performance of a small subset of design candidates. Augmenting the grammar with data-driven models may significantly reduce the amount of time required to generate a set of design candidates that meet the desired design criteria. In an aspect, the disclosed techniques may achieve a factor of 6 speed-up over the symbolic generator 504 by augmenting the grammar with data-driven models. Such a difference in performance may be a significant improvement, and it may demonstrate the potential of data-driven approaches for improving the efficiency of the design generation process. Data-driven models may be trained on a dataset of existing design examples and their corresponding performance metrics. Such training may allow the data-driven models to predict the performance of new design candidates without having to run expensive simulations. Data-driven models may be used to identify promising design candidates from a large set of possible design candidates. Accordingly, data-driven models may help to reduce the amount of time required to find a design candidate that meets the desired design criteria. Data-driven models may be used to guide the design process by providing feedback on the performance of design candidates. Such guidance may help designers to avoid making costly mistakes and to produce better designs in a shorter amount of time.

FIG. 6 is a conceptual diagram illustrating an example representation of design according to techniques of this disclosure. The interface between the symbolic generator 504 and the data-driven component may require a sequence of steps to convert from the design language to the numerical input to a machine learning model. The design 602 may be converted to a context preserving sequence 604 because the symbolic generator 504 may represent the design 602 in a symbolic form, while the transformer learning model 502 may expect numerical input. The context preserving sequence 604 may be a way of converting the symbolic representation of the design to a numerical representation that preserves the context of the design 602. The first step may be to parse the design language to extract the key features of the design 602. The parsing step may be implemented using a variety of techniques, such as, but not limited to, natural language processing (NLP) or rule-based parsing. Once the key features of the design 602 have been extracted, these key features may be encoded into numerical values.

In an aspect, the design 602 may be converted into the design sequence 604 by first generating the design tree 606. The design tree 606 may be a hierarchical representation of the design 602 structure. The design tree 606 may show the relationships between the different components of the design 602 and how these components may interact with each other.

Embedding the design sequence 604 into a vector while preserving the context of each component is an important step in the design generation process because this step may allow the transformer model 502 to learn the relationships between the different components of the design 602 and to predict the performance of the design 602 based on these relationships. There are a variety of techniques to embed the design sequence 604 into a vector while preserving the context of each component. One common technique is to use a positional encoding. A positional encoding is a vector that represents the position of each component in the design sequence 604. The positional encoding may allow the transformer model 502 to learn the order of the components in the design sequence 604 and to identify patterns in the design sequence 604. Another common technique to embedding the design sequence 604 into a vector while preserving the context of each component is to use a graph-based embedding. A graph-based embedding is a vector that may represent the relationships between the different components of the design.

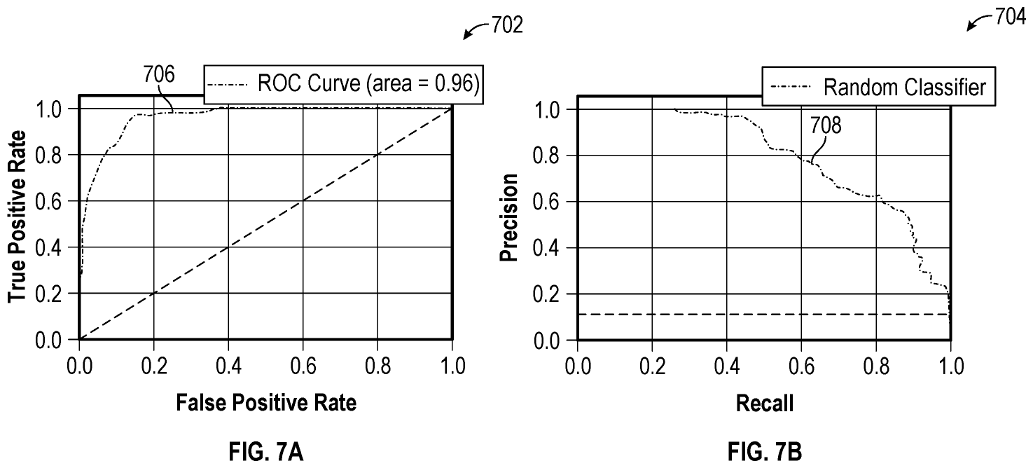

FIGS. 7A and 7B are graphs 702-704 illustrating an example of results on an example corpus according to techniques of this disclosure. As shown in FIGS. 7A and 7B the ROC AUC (Receiver Operating characteristic Curve - Area Under the Curve) curve 706 for classification of airworthy UAV, and Precision-Recall curve 708 for classification of airworthy performed by the transformer model 502 of the disclosed neurosymbolic generator 250 may indicate that the transformer model 502 may be performing well at classifying designs as good or bad, even on highly imbalanced data. Accuracy is a measure of how often the model predicts correctly. In this case, an accuracy of 93% means that the transformer model 502 may correctly predict whether a design is good or bad 93% of the time. ROC AUC is a measure of how well a model can distinguish between positive and negative cases. A ROC AUC of 0.96 means that the transformer model 502 may be able to distinguish between good and bad designs with a high degree of accuracy. Precision-Recall is a measure of how often the transformer model 502 correctly predicts positive cases and how often it avoids predicting negative cases. A good Precision-Recall score indicates that the transformer model 502 may be able to identify good designs without falsely predicting that bad designs are good.

Inferring other attributes of the design such as interferences and actual flight distance may significantly reduce the waiting time for a valid design because it may allow the design generation system to filter out design candidates that are likely to be infeasible or to have poor performance. For example, if the design generation system 204 may infer that a design candidate is likely to have interference issues, the design generation system 204 may filter out that candidate without having to run a time-consuming simulation. Such inference may save a significant amount of time in the design process. Similarly, if the design generation system 204 may infer that a design candidate is likely to have a poor flight distance, the design generation system 204 may filter out that candidate without having to run a time-consuming simulation. Such inference may also save a significant amount of time in the design process. Inferring other attributes of the design may also help the design generation system 204 to generate better design candidates. For example, if the design generation system 204 knows that a design candidate is likely to have interference issues, the design generation system 204 may try to modify the design to avoid those issues.

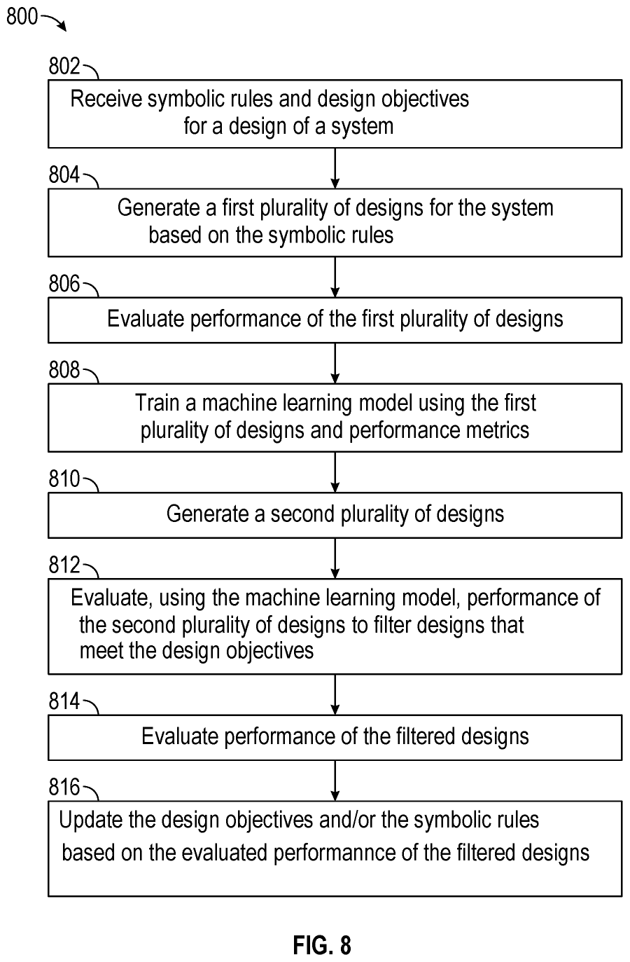

FIG. 8 is a flowchart illustrating an example mode of operation for a design generation system, according to techniques described in this disclosure. Although described with respect to computing system 200 of FIG. 2 having processing circuitry 243 that executes design generation system 204, mode of operation 800 may be performed by a computation system with respect to other examples of machine learning systems described herein.

In mode operation 800, processing circuitry 243 executes design generation system 204. Design generation system 204 may receive a plurality of symbolic rules and a plurality of design objectives for a design of a system (802). Design generation system 204 may generate a first plurality of designs for the system based on the plurality of the symbolic rules (804) using the neurosymbolic generator 250. Design generation system 204 may next evaluate, using a simulation model, performance of the first plurality of designs (806). train a machine learning model using the first plurality of designs and performance metrics (808). Design generation system 204 may generate a second plurality of designs (810). Design generation system 204 may next evaluate, using the machine learning model, performance of the second plurality of designs to filter one or more designs that meet one or more of the plurality of the design objectives (812). Next, the design generation system 204 may evaluate performance of the filtered designs (814). Finally, the design generation system 204 may update the plurality of the design objectives and/or the plurality of the symbolic rules based on the evaluated performance of the filtered designs such that the plurality of symbolic rules and the plurality of the design objectives become more restrictive (816).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. An iterative method for generating designs in a computationally efficient manner, comprising:
receiving, by a computing system, a plurality of symbolic rules and a plurality of design objectives for a design of a system;
generating, by the computing system, a first plurality of designs for the system based on the plurality of the symbolic rules;
evaluating, by the computing system, performance of the first plurality of designs;
training, by the computing system, a machine learning model using the first plurality of designs and performance metrics;
generating, by the computing system, a second plurality of designs;
evaluating, by the computing system, using the machine learning model, performance of the second plurality of designs to filter one or more designs that meet one or more of the plurality of the design objectives;
evaluating, by the computing system, performance of the filtered designs; and
updating, by the computing system, the plurality of the design objectives and/or the plurality of the symbolic rules based on the evaluated performance of the filtered designs such that the plurality of symbolic rules and the plurality of the design objectives become more restrictive.

2. The method of claim 1, wherein the first plurality of designs comprises a diverse set of designs.

3. The method of claim 1, wherein the plurality of design objectives comprises control objectives and/or physical objectives.

4. The method of claim 3, wherein the plurality of design objectives are represented by a design tree having a hierarchical representation of a design structure.

5. The method of claim 4, further comprising:
converting the design tree into a design sequence; and
embedding the design sequence into a vector.

6. The method of claim 1, wherein generating the first plurality of designs comprises randomly varying a plurality of stochastic parameters associated with the design of the physical object to generate the first plurality of designs.

7. The method of claim 1, wherein generating the first plurality of designs comprises generating, by a neurosymbolic generator using a stochastic grammar, the first plurality of designs.

8. The method of claim 7, wherein updating the plurality of symbolic rules comprises tuning the stochastic grammar used by the neurosymbolic generator based on structure and one or more parameters of the filtered designs.

9. The method of claim 1, further comprising iteratively re-training the machine learning model using the second plurality of designs, wherein the second plurality of designs includes the one or more designs that meet one or more of the plurality of the design objectives and one or more designs that do not meet any of the plurality of the design objectives.

10. The method of claim 1, wherein the system comprises a physical system.

11. A computing system comprising:
an input device configured to receive a plurality of symbolic rules and a plurality of design objectives for a design of a system;
processing circuitry and memory for executing a design generation system, wherein the design generation system is configured to:
generate a first plurality of designs for the system based on the plurality of the symbolic rules;
evaluate performance of the first plurality of designs;
train a machine learning model using the first plurality of designs and performance metrics;
generate a second plurality of designs;
evaluate, using the machine learning model, performance of the second plurality of designs to filter one or more designs that meet one or more of the plurality of the design objectives;
evaluate performance of the filtered designs; and
update the plurality of the design objectives and/or the plurality of the symbolic rules based on the evaluated performance of the filtered designs such that the plurality of symbolic rules and the plurality of the design objectives become more restrictive.

12. The system of claim 11, wherein the first plurality of designs comprises a diverse set of designs.

13. The system of claim 11, wherein the plurality of design objectives comprises control objectives and/or physical objectives.

14. The system of claim 13, wherein the plurality of design objectives are represented by a design tree having a hierarchical representation of a design structure.

15. The system of claim 14, wherein the design generation system is further configured to:
convert the design tree into a design sequence; and
embed the design sequence into a vector.

16. The system of claim 11, wherein the design generation system configured to generate the first plurality of designs is further configured to randomly vary a plurality of stochastic parameters associated with the design of the physical object to generate the first plurality of designs.

17. The system of claim 11, wherein the design generation system configured to generate the first plurality of designs is further configured to generate, by a neurosymbolic generator using a stochastic grammar, the first plurality of designs.

18. The system of claim 17, wherein the design generation system configured to update the plurality of symbolic rules is further configured to tune the stochastic grammar used by the neurosymbolic generator based on structure and one or more parameters of the filtered designs.

19. The system of claim 11, wherein the design generation system is further configured to iteratively re-train the machine learning model using the second plurality of designs, wherein the second plurality of designs includes the one or more designs that meet one or more of the plurality of the design objectives and one or more designs that do not meet any of the plurality of the design objectives.

20. Non-transitory computer-readable media comprising machine readable instructions for configuring processing circuitry to:
receive a plurality of symbolic rules and a plurality of design objectives for a design of a system;
generate a first plurality of designs for the system based on the plurality of the symbolic rules;
evaluate performance of the first plurality of designs;
train a machine learning model using the first plurality of designs and performance metrics;
generate a second plurality of designs;
evaluate, using the machine learning model, performance of the second plurality of designs to filter one or more designs that meet one or more of the plurality of the design objectives;
evaluate performance of the filtered designs; and
update the plurality of the design objectives and/or the plurality of the symbolic rules based on the evaluated performance of the filtered designs such that the plurality of symbolic rules and the plurality of the design objectives become more restrictive.
